(19) United States
(12) Patent Application Publication
(10) Pub. No.: US 2025/0211097 A1
(43) Pub. Date: Jun. 26, 2025

(54) POWER CONTROL DEVICE AND POWER CONTROL METHOD

(71) Applicant: Delta Electronics (Shanghai) Co.,Ltd., Shanghai (CN)

(72) Inventors: Fengkai JIANG, Shanghai (CN); Bingtao HU, Shanghai (CN); Haitao ZHANG, Shanghai (CN)

(21) Appl. No.: 19/000,580

(22) Filed: Dec. 23, 2024

(30) Foreign Application Priority Data
Dec. 25, 2023 (CN) 202311804728.5

(51) Int. Cl. H02M 1/32; H02M 1/42; H02M 3/24

(52) U.S. Cl. CPC H02M 1/327; H02M 1/4208; H02M 3/24

(57) ABSTRACT

The present disclosure discloses a power control device and a power control method. The power control device comprises: a power conversion unit having a primary circuit and a secondary circuit connected through a transformer, the power conversion unit configured to receive an AC input voltage of an AC power source and convert the AC input voltage into an output voltage for a load; and a control unit configured to control an actual output power not to exceed a maximum power limit according to a temperature signal and an input voltage signal, wherein the maximum power limit is the smaller one between a first maximum power value and a second maximum power value, and the first maximum power value is associated with the temperature signal and the second maximum power value is associated with the input voltage signal.

### CROSS-REFERENCE TO RELATED APPLICATIONS

This non-provisional application claims priority under 35 U.S.C. § 119(a) on Patent application Ser. No. 202311804728.5 filed in P.R. China on Dec. 25, 2023, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### BACKGROUND OF THE INVENTION

### 1. Field of the Present Disclosure

The present disclosure relates to a power electronic technology, and particularly to a power control device and a power control method.

### 2. Related Art

Energy of power adapters lost in running is mainly dissipated in the form of heat, and often relies on natural heat dissipation under windless conditions, and power transmission efficiency directly decides actual temperature rise itself. In order to consider mains voltage input within the global range, power adapters often shall consider an input voltage range from 90 Vac to 264 Vac when designed. Depending on topological schemes used inside the power adapters, the transmission efficiency of the power adapters under different AC input voltages differs, and design of the rated power often takes the sustainable running maximum transmission power under the worse heat dissipation condition as reference, which largely limits the maximum power output capability under other good heat dissipation conditions.

Taking the common single-stage Flyback scheme for example, conduction loss under a rated output plays a dominant role, running efficiency of the power source under a high-voltage input is higher than that of a low-voltage input, and 90 Vac input often corresponds to the worse heat dissipation condition, and also indirectly decides the maximum output power that the power adapters can long-term and stably run, while 230 Vac input often has a relatively better heat dissipation condition, and theoretically, can output a higher power. As for PFC+Flyback scheme, working efficiency of PFC level under the high-voltage input is also higher than that of the low-voltage input, so overall efficiency under the high-voltage input is more advantageous obvious, and correspondingly, overall temperature rise will be also obviously reduced. This also means that under the same requirement for temperature rise, power transmission capability under the high-voltage input is stronger.

As can be seen, the overall working efficiency of the power adapters under different AC voltage inputs differs, which directly affects transmission loss and overall temperature rise when the power source runs.

Therefore, how to provide a power control device and a power control method to release the output power to the maximum extent becomes one of the problems to be urgently solved in the industry.

### SUMMARY OF PRESENT DISCLOSURE

An object of the present disclosure is to provide a power control device and a power control method, which can effectively solve at least one deficiency in the prior art.

In order to achieve the object, the present disclosure provides a power control device, including a power conversion unit having a primary circuit and a secondary circuit connected through a transformer, wherein the power conversion unit is configured to receive an AC input voltage of an AC power source and convert the AC input voltage into an output voltage for a load.; and a control unit configured to control an actual output power not to exceed a maximum power limit according to a temperature signal and an input voltage signal, wherein the maximum power limit is the smaller one between a first maximum power value and a second maximum power value, and the first maximum power value is associated with the temperature signal and the second maximum power value is associated with the input voltage signal.

In some embodiments of the invention, the control unit is configured to: when the input voltage signal corresponds to a first voltage, the first power threshold is used as the second maximum power value; when the input voltage signal corresponds to a second voltage, the second power threshold is used as the second maximum power value, wherein the first voltage is smaller than the second voltage, and the second power threshold is greater than the first power threshold.

In some embodiments of the invention, the power control device is a power adapter, and the first power threshold is equal to a rated power of the power adapter, and the second power threshold is greater than the rated power of the power adapter.

In some embodiments of the invention, the input voltage signal is detected by a voltage detection unit, and the voltage detection unit has a detection node between the AC power source and the primary circuit.

In some embodiments of the invention, the power control device further includes a rectifier circuit having an input end electrically coupled to an output end of the AC power source and an output end electrically coupled to the primary circuit, wherein the detection node is located at the output end of the AC power source or the output end of the rectifier circuit.

In some embodiments of the invention, the power control device further includes a power factor correction circuit electrically coupled between the output end of the rectifier circuit and the primary circuit, wherein the input voltage signal is detected from the output end of the rectifier circuit before the power factor correction circuit starts up.

In some embodiments of the invention, the control unit is configured to: when the temperature signal is less than a first temperature threshold, the third power threshold is used as the first maximum power value; when the temperature signal is greater than a second temperature threshold, the control unit performs over-temperature protection for the power control device; when the temperature signal is between the first temperature threshold and the second temperature threshold, a fourth power threshold is used as the first maximum power value; wherein the first temperature threshold is less than the second temperature threshold, and the third power threshold is greater than the fourth power threshold.

In some embodiments of the invention, the power control device is a power adapter, the first temperature threshold is 80° C., and the third power threshold is 120% of a rated power of the power adapter, and the second temperature threshold is 100° C., and the fourth power threshold is the rated power of the power adapter.

In some embodiments of the invention, the temperature signal is detected by sampling a temperature of the power control device itself.

In some embodiments of the invention, the voltage detection unit is further configured to process the input voltage signal, such that the processed input voltage signal is identified as a first voltage or a second voltage by the control unit, wherein the first voltage is smaller than the second voltage.

In some embodiments of the invention, the voltage detection unit includes:
a plurality of voltage-dividing resistors at least comprising a first voltage-dividing resistor and a second voltage-dividing resistor sequentially connected in series between the detection node and a ground end;
a filter capacitor connected in parallel to the second voltage-dividing resistor;
a voltage comparator having a non-inverting input end connected to a reference voltage, an inverting input end connected to a junction node between the first voltage-dividing resistor and the second voltage-dividing resistor, and a power supply end connected to a DC power source, and a comparison output end; and
a switch having a switch input end connected to the comparison output end of the voltage comparator, and a switch output end;
the power control device further including a signal isolation unit having a first input end and a first output end, wherein the first input end of the signal isolation unit is connected to the switch output end of the switch, and the first output end of the signal isolation unit is connected to the control unit.

In some embodiments of the invention, the voltage detection unit includes:
a plurality of voltage-dividing resistors at least comprising a first voltage-dividing resistor and a second voltage-dividing resistor sequentially connected in series between the detection node and a ground end, and a filter capacitor connected in parallel to the second voltage-dividing resistor;
a three-terminal voltage stabilizer having a cathode, an anode and a reference electrode, and a switching element having a drive end, a switch input end and a switch output end; and
a cathode resistor, a current-limiting resistor, a driving resistor and a voltage stabilizing diode, wherein the cathode resistor is electrically connected between a DC power source and the cathode of the three-terminal voltage stabilizer, the driving resistor and the voltage stabilizing diode are connected in series between the cathode of the three-terminal voltage stabilizer and the drive end of the switching element, and the current-limiting resistor is electrically connected between the DC power source and the switch input end of the switching element;
the power control device further comprising a signal isolation unit having a first input end and a first output end, wherein the first input end of the signal isolation unit is connected to the switch output end of the switching element, and the first output end of the signal isolation unit is connected to the control unit;
In some embodiments of the invention, the signal isolation unit is a optocoupler or a transformer.

In some embodiments of the invention, the power control device further includes: a secondary current detection unit between the secondary circuit and the load, wherein the secondary current detection unit is electrically connected to the control unit; the control unit further in communication connection with the load through a communication line; wherein when the input voltage signal is corresponds to a first voltage, the control unit indicates that the power control device has a first current pumping capability, and limits an overcurrent protection current threshold of the secondary circuit to be a first current value; wherein when the input voltage signal is corresponds to a second voltage, the control unit indicates that the power control device has a second current pumping capability, and limits the overcurrent protection current threshold of the secondary circuit to be a second current value; wherein the first voltage is smaller than the second voltage, and the second power threshold is greater than the first power threshold, and a current value corresponding to the first current pumping capability is less than a current value corresponding to the second current pumping capability, and the first current value is less than the second current value.

In some embodiments of the invention, the first voltage ranges from 100Vac to 127Vac, and the second voltage ranges from 200 Vac to 240Vac.

In some embodiments of the invention, a signal isolation unit between the voltage detection unit and the control unit and electrically isolating the input voltage signal, wherein the control unit is electrically connected to the secondary circuit.

In order to achieve the object, the invention further provides a power control method, including:
provides a power conversion unit having a primary circuit and a secondary circuit connected through a transformer, wherein the power conversion unit is configured to receive an AC input voltage of an AC power source and convert the AC input voltage into an output voltage for a load; and the power conversion has a control unit, the control unit controlling an actual output power not to exceed a maximum power limit according to a temperature signal and an input voltage signal, wherein the maximum power limit is the smaller one between a first maximum power value and a second maximum power value, and the first maximum power value is associated with the temperature signal and the second maximum power value is associated with the input voltage signal.

Additional aspects and advantages of the invention are partially explained in the below description, and partially become apparent from the description, or can be obtained from practice of the invention.

### BRIEF DESCRIPTION OF THE DRAWINGS

Exemplary embodiments are described in details with reference to the accompanying drawings, and the above and other features and advantages of the present disclosure become more apparent.

FIG. 1 is a block diagram of working principle of a power control device according to the present disclosure.

FIG. 2 is a block diagram of control logic of the power control device according to the present disclosure.

FIG. 3A shows a preferable embodiment of a voltage detection unit 50 in FIG. 1.

FIG. 3B shows another preferable embodiment of the voltage detection unit 50 in FIG. 1.

FIG. 4 is a flow diagram of a power control method according to the present disclosure.

FIG. 5 is a preferable embodiment of a power control device according to the present disclosure.

### DETAILED EMBODIMENTS OF THE PRESENT DISCLOSURE

Now the exemplary embodiments are comprehensively described with reference to the accompanying drawings. However, the exemplary embodiments can be implemented in various forms, and shall not be understood to be limited to the described embodiments. On the contrary, these embodiments are provided to make the present disclosure comprehensive and complete, and concept of the exemplary embodiments is fully conveyed to those skilled in the art. The same reference signs in the drawings represent the same or similar structure, so detailed descriptions are omitted.

When introducing the described and/or illustrated elements or components or the like, the words “one”, “first”, “the” and “at least one” represent one or more elements or components or the like. The terms “comprise”, “include” and “have” represent an open and including meaning, and refer to other elements or components or the like, except listed elements or components or the like. The word “connection” represents direct connection, or indirect connection between two elements or components (i.e., there are also other elements or components between the two elements or components, for example, including but not limited to air). Moreover, the terms “first”, “second” and the like in the claims are only used as signs, instead of limiting the numbers of the object.

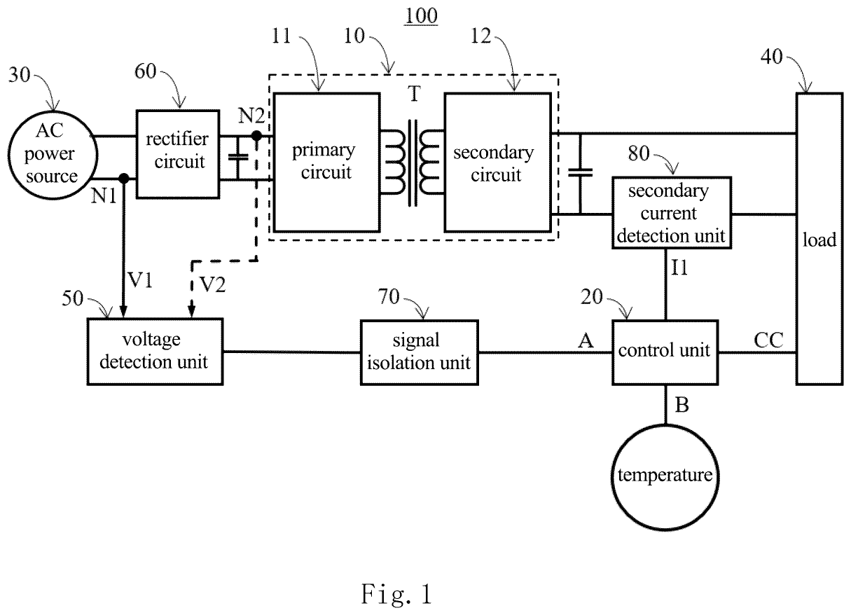

As shown in FIG. 1, it shows a block diagram of working principle of a power control device 100 according to the present disclosure. The power control device 100 of the present disclosure mainly includes a power conversion unit 10 and a control unit 20. The power conversion unit 10 has a primary circuit 11 and a secondary circuit 12 connected through a transformer T. The power conversion unit 10 may be configured to receive an AC input voltage of an AC power source and convert the AC input voltage into an output voltage for a load. The control unit 20 may be configured to control an actual output power 40 not to exceed a maximum power limit according to a temperature signal B and an input voltage signal A, and the maximum power limit is a smaller value in a first maximum power value associated with the temperature signal B and a second maximum power value associated with the input voltage signal A.

In some embodiments of the present disclosure, the power control device 100, for example, may be a power adapter, and preferably, for example, may be a power adapter that meets the USB power delivery (PD) standard, but the present disclosure is not limited thereto. The power control device 100 of the present disclosure may also be deduced to application of other power sources, such as, on board chargers (OBCs).

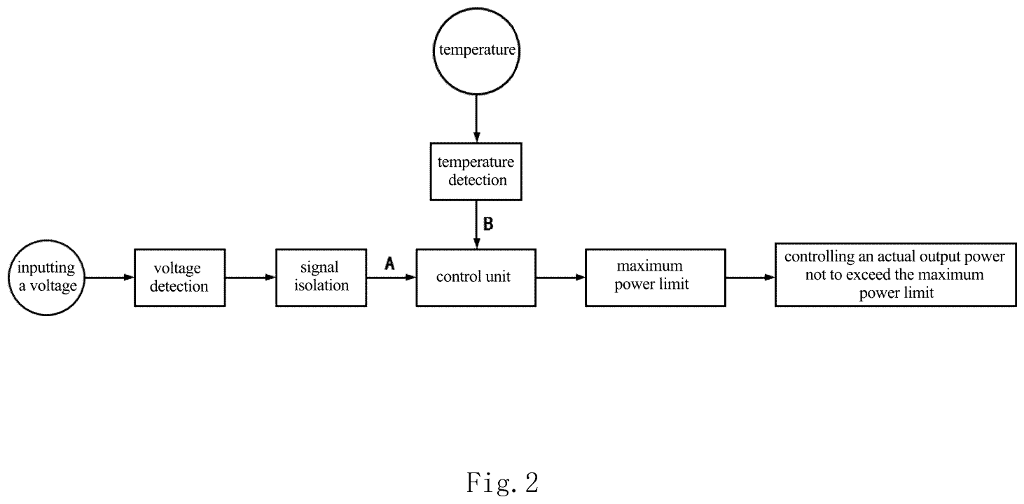

As shown in FIG. 2, it shows specific control logic of the power control device 100 according to the present disclosure. The input voltage signal may be processed and sent to the control unit (e.g., the control unit 20 in FIG. 1), and the input voltage signal sent to the control unit, for example, is marked as A. The temperature signal may be processed and sent to the control unit, and the temperature signal sent to the control unit, for example, is marked as B. In actual control, the input voltage signal A and the temperature signal B are in an “and” relation, and if the second maximum power value associated with the input voltage signal A is Pmax_A, and the first maximum power value associated with the temperature signal B is Pmax_B, the maximum power limit obtained according to the present disclosure is min (Pmax_A, Pmax_B), i.e., a smaller value in Pmax_A and Pmax_B. The control unit of the present disclosure may finally control the actual output power not to exceed the maximum power limit min (Pmax_A, Pmax_B).

Please continue to refer to FIG. 1, in some embodiments of the present disclosure, the power control device 100 may also preferably include a rectifier circuit 60, and has an input end electrically connected to an output end of the AC power source 30, and an output end electrically connected to the primary circuit 11. In the present disclosure, the input voltage signal A, for example, may be acquired from a detection node between the AC power source 30 and the primary circuit 11 through a voltage detection unit 50. In the embodiment of FIG. 1, the detection node can be located at the output end (such as, a node N1) of the AC power source 30, or located at the output end (such as, a node N2) of the rectifier circuit 60, but the present disclosure is not limited thereto.

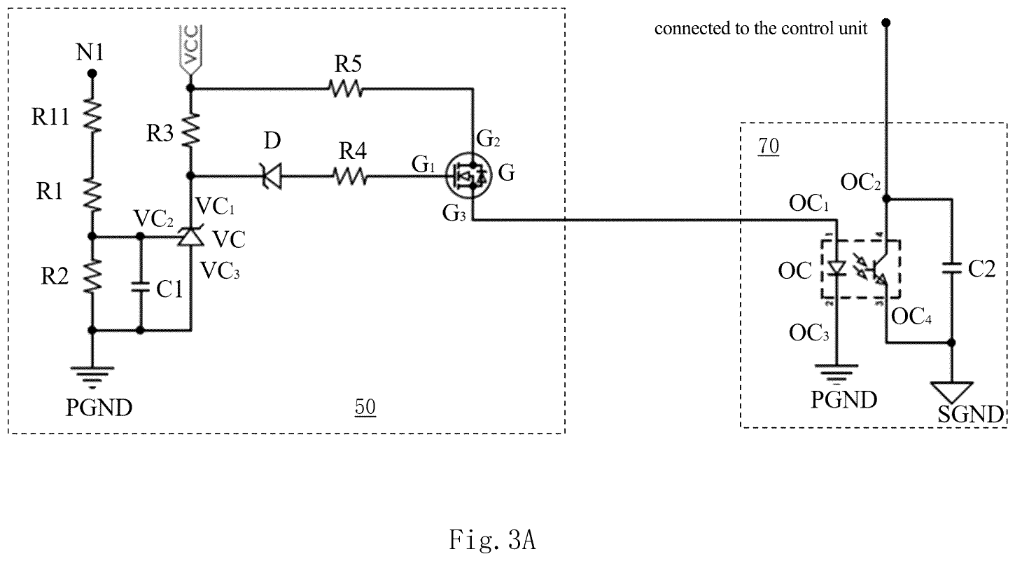

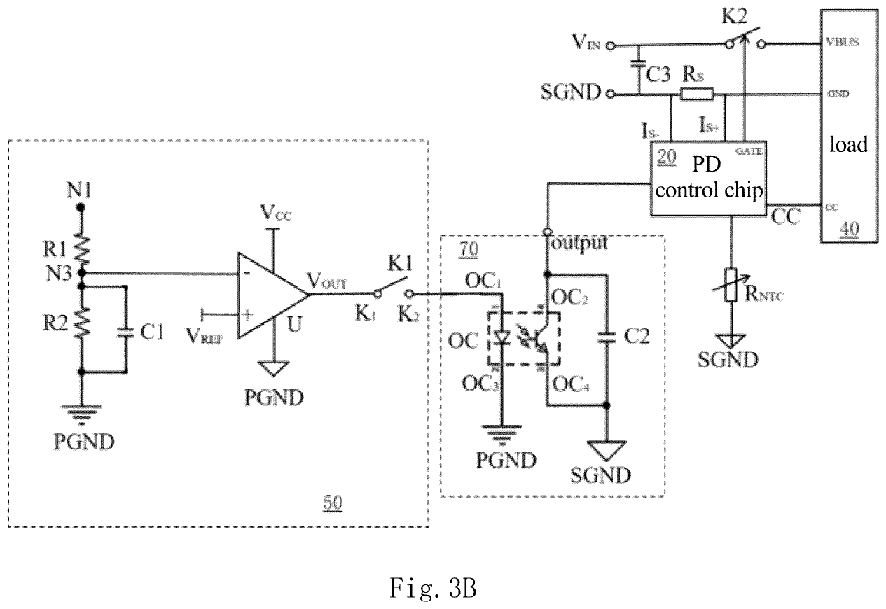

In some embodiments of the present disclosure, as for the circumstance where a detection signal is at a primary side of the transformer T, a signal isolation device may be further used for electrical isolation. In other words, the power control device 100 of the present disclosure may further include a signal isolation unit 70 connected between the voltage detection unit 50 and the control unit 20 and electrically isolating the input voltage signal, wherein the control unit 20 is electrically connected to the secondary circuit 12. Preferably, the signal isolation unit 70, for example, may be a optocoupler (shown by “OC” in FIG. 3A or 3B) or a transformer. Of course, it can be understood that other devices for electrical isolation are also feasible, but the present disclosure is not limited thereto.

Taking the embodiment of FIG. 1 for example, the voltage detection unit 50 may acquire input voltage signals V1 from the node N1, or acquire input voltage signals V2 from the node N2. These input voltage signals V1 or input voltage signals V2 are sent to the control unit 20 after processing. In the present disclosure, the “processing” includes but not limited to process the input voltage signals V1 or input voltage signals V2 to be signals that can be recognized by the control unit (e.g., the secondary PD control chip) and/or further processed subsequently, and/or, for example, electrically isolate the input voltage signals V1 or input voltage signals V2.

In some embodiments of the present disclosure, the temperature signal B may be acquired by sampling a temperature of the power control device 100 itself, specification, acquired by sampling a temperature of devices that reflect the overall temperature in the power control device 100, or may also be acquired by sampling a temperature of the secondary circuit 12, but the present disclosure is not limited thereto. In addition, the way of sampling the temperature includes but not limited to sample by the way of using a temperature sensor.

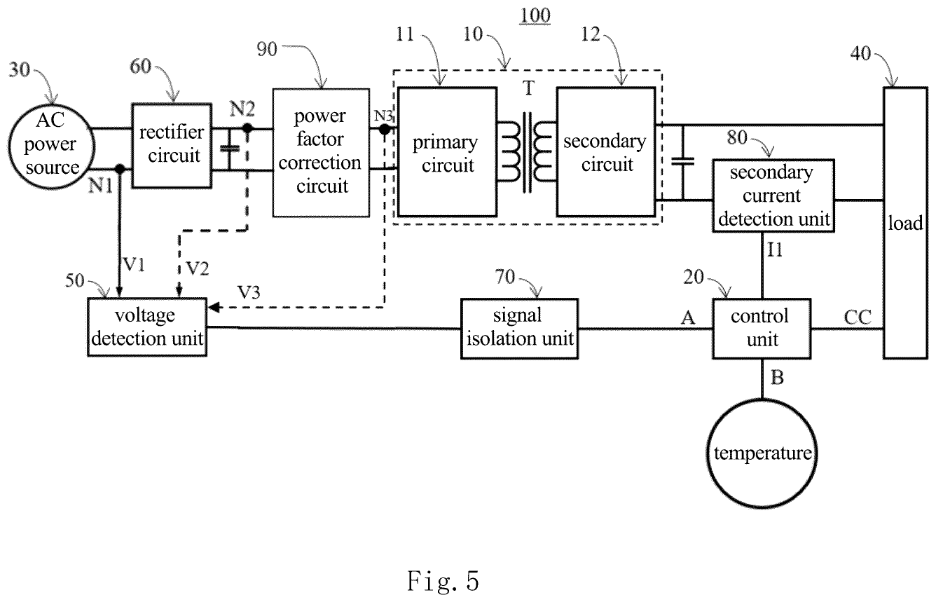

In some embodiments of the present disclosure, the power control device 100 may further include a power factor correction circuit 90 (as shown in FIG. 5). The power factor correction circuit 90, for example, may be electrically connected between the output end of the rectifier circuit 60 and the primary circuit 11. In some embodiments, the voltage detection unit 50, for example, may also acquire input voltage signals V3 through an output end (a node N3) of the power factor correction circuit 90, and the input voltage signals V3 shall be acquired before starting the power factor correction circuit 90. The reason of acquiring the input voltage signal before starting the power factor correction circuit 90 is that the power factor correction circuit 90 adjusts the input voltage signal after starting, and cannot correctly reflect a relative size of the input voltage signal.

In some embodiments of the present disclosure, the control unit 20 may be configured to: when the input voltage signal A is a low-voltage input, use a first voltage allowable power as the second maximum power value; when the input voltage signal A is a high-voltage input, use a second voltage allowable power as the second maximum power value; wherein the second voltage allowable power is greater than the first voltage allowable power. Preferably, a voltage range of the low-voltage input, for example, may be 100 Vac to 127Vac, and a voltage range of the high-voltage input, for example, may be 200 Vac to 240Vac, but the present disclosure is not limited thereto.

Taking the power control device 100 being a power adapter having a rated power 100 W for example, the first voltage allowable power, for example, is equal to a rated power (i.e., “the first voltage allowable power=100 W”) of the power adapter, and the second voltage allowable power, for example, is greater than a rated power (i.e., “the second voltage allowable power >100 W”, for example, 130 W, but the present disclosure is not limited thereto) of the power adapter. In such way, when the input voltage signal A is a low-voltage input, the first voltage allowable power may be used as the second maximum power value (i.e., Pmax_A=100 W), and when the input voltage signal A is a high-voltage input, the second voltage allowable power may be used as the second maximum power value (i.e., Pmax_A=130 W).

Correspondingly, in some embodiments, the voltage detection unit 50 may be further configured to process the input voltage signal (such as, the input voltage signal V1 or V2 in FIG. 1), such that the input voltage signal A after processing can be recognized by the control unit 20 to be a low-voltage input or a high-voltage input.

In some embodiments of the present disclosure, the control unit 20 may be further configured to: when the temperature signal B is less than a first threshold, use a first temperature allowable power as the first maximum power value; when the temperature signal B is greater than a second threshold, the control unit controls the power control device for over-temperature protection; when the temperature signal B is between the first threshold and the second threshold, use a second temperature allowable power as the first maximum power value; wherein the first threshold is less than the second threshold, and the first temperature allowable power is greater than the second temperature allowable power.

Similarly, taking the power control device 100 being the power adapter having a rated power 100 W for example, the first threshold, for example, may be 80° C., the first temperature allowable power, for example, may be 120% of a rated power of the power adapter (i.e., “the first temperature allowable power=120 W”), the second threshold, for example, may be 100° C., and the second temperature allowable power, for example, may be the rated power of the power adapter (i.e., “the second temperature allowable power=100 W”). In such way, when the temperature signal B is less than 80° C. (i.e., the first threshold), the first temperature allowable power may be used as the first maximum power value (i.e., Pmax_B=120 W); when the temperature signal B is greater than 100° C. (i.e., the second threshold), the control unit 20 controls the power control device 100 for over-temperature protection (OTP); when the temperature signal B is between 80° C. and 100° C., the second temperature allowable power is used as the first maximum power value (i.e., Pmax_B=100 W).

As shown in FIG. 3A, it shows a preferable embodiment of the voltage detection unit 50 in FIG. 1. In this embodiment, preferably, the voltage detection unit 50, for example, may include a plurality of voltage-dividing resistors (such as, R1, R2, R11), a filter capacitor C1, a three-terminal voltage stabilizer VC (such as, TL431), a switching element G, a cathode resistor R3, a current-limiting resistor R5, a driving resistor R4 and a voltage stabilizing diode D. The plurality of voltage-dividing resistors, for example, may at least include a first voltage-dividing resistor R1 and a second voltage-dividing resistor R2 sequentially connected in series between a detection node (such as, a node N1 in FIG. 1) and a ground end PGND (such as, a primary reference ground). The filter capacitor C1 is connected in parallel to the second voltage-dividing resistor R2. The three-terminal voltage stabilizer VC has a cathode VC1, a reference electrode VC2 and an anode VC3. The switching element G has a drive end G1, a switch input end G2 and a switch output end G3. The cathode resistor R3 is electrically connected between a DC power source VCC and the cathode VC1 of the three-terminal voltage stabilizer VC. The driving resistor R4 and the voltage stabilizing diode D are connected in series between the cathode VC1 of the three-terminal voltage stabilizer VC and the drive end G1 of the switching element G. The current-limiting resistor R5 is electrically connected between the DC power source VCC and the switch input end G2 of the switching element G. The voltage stabilizing diode D is configured to match a voltage at VC1 when the three-terminal voltage stabilizer VC outputs a high level, such that the switching element G is in a turn-on state, and match a voltage at VC1 when the three-terminal voltage stabilizer VC outputs a low level, such that the switching element G is in a turn-off state.

In the embodiment of FIG. 3A, it also shows a connection relation between the voltage detection unit 50 and the signal isolation unit 70. In FIG. 3A, the signal isolation unit 70, for example, is a optocoupler OC, and has a first input end OC1 connected to a switch output end G3 of the switching element G, and a first output end OC2 connected to the control unit (i.e., the control unit 20 in FIG. 1). When the input voltage signal A of the power control device 100 of the present disclosure is the high-voltage input (at this time, AC output of the AC power source is a high-voltage output), the cathode VC1 of the three-terminal voltage stabilizer VC outputs a low level, the switching element G is turned off, and the first output end OC2 of the signal isolation unit 70 (such as, the optocoupler OC) outputs a high level. When the input voltage signal A of the power control device 100 of the present disclosure is the low-voltage input (at this time, AC output of the AC power source is a low-voltage output), the cathode VC1 of the three-terminal voltage stabilizer VC outputs a high level, the switching element G is turned on, and the first output end OC2 of the signal isolation unit 70 (such as, the optocoupler OC) outputs a low level. The control unit 20 recognizes the input voltage signal to be the high-voltage input or the low-voltage input according to the high or low level outputted from the first output end OC2 of the signal isolation unit 70.

In some other embodiments of the present disclosure, the plurality of voltage-dividing resistors, for example, may further include a third voltage-dividing resistor R11, or may further include more numbers of voltage-dividing resistors, but the present disclosure is not limited thereto. The signal isolation unit 70 (such as, the optocoupler OC), for example, may also have one terminal OC3 connected to a ground end PGND (such as, a primary reference ground), and a capacitor C2 connected in parallel between the first output end OC2 and another terminal OC4, and the another terminal OC4 connected to a ground end SGND (such as, a secondary reference ground), but the present disclosure is also not limited thereto.

As shown in FIG. 3B, it shows another preferable embodiment of the voltage detection unit 50 in FIG. 1. In this embodiment, preferably, the voltage detection unit 50, for example, may include a plurality of voltage-dividing resistors (such as, R1, R2), a filter capacitor C1, a voltage comparator U and a switching element K1. The plurality of voltage-dividing resistors, for example, may at least include a first voltage-dividing resistor R1 and a second voltage-dividing resistor R2 sequentially connected in series between a detection node (such as, a node N1 in FIG. 1) and a ground end PGND (such as, a primary reference ground). The filter capacitor C1 is connected in parallel to the second voltage-dividing resistor R2. The voltage comparator U may have an in-phase input end (i.e., “+” end) connected to a reference voltage V_{REF}, an inverting input end (i.e., “−” end) connected to a connection node N3 between the first voltage-dividing resistor R1 and the second voltage-dividing resistor R2, a power source end particularly including a power source positive end and a power source negative end, wherein the power source positive end is connected to a DC power source V_{CC}, and the power source negative end is connected to the secondary ground end, and a comparison output end V_{OUT}. The switching element K1 has a switch input terminal K1 connected to the comparison output end V_{OUT} of the voltage comparator U, and a switch output end K₂ connected to the first input end OC1 of the signal isolation unit 70 (such as, the optocoupler OC) of the power control device, and the first output end OC₂ of the signal isolation unit 70 is connected to the control unit 20 (such as, a PD control chip). When the input voltage signal is the high-voltage input, the comparison output end V_{OUT} of the voltage comparator U outputs a low level, the switching element K1 is turned off, and the first output end OC₂ of the signal isolation unit 70 (such as, the optocoupler OC) outputs a high level. When the input voltage signal is the low-voltage input, the comparison output end V_{OUT} of the voltage comparator U outputs a high level, the switching element K1 is turned on, and the first output end OC₂ of the signal isolation unit (such as, the optocoupler OC) outputs a low level. The control unit 20 recognizes the input voltage signal to be the high-voltage input or the low-voltage input according to the high or low level outputted from the first output end OC₂ of the signal isolation unit 70.

In the embodiment of FIG. 3B, it further shows some connection relations between the control unit 20 and the load 40. In FIG. 3B, the control unit 20 (such as, a PD control chip), for example, is also connected to a thermistor R_{NTC}, and the thermistor R_{NTC} is connected to a ground end SGND (such as, a secondary reference ground). The temperature signal B, for example, is acquired by the thermistor R_{NTC}. The control unit 20 can also be in communication connection with a port cc of the load 40 through a communication line CC. A port GND of the load 40, for example, may be connected to a ground end SGND (such as, a secondary reference ground) through a detection resistor Rs. Currents I_{S-} and I_{S+} at both ends of the detection resistor Rs are sent into the control unit 20. A port V_{BUS} of the load 40, for example, may be connected to an input voltage Vᵢₙ through a controllable switch K2. On or off of the controllable switch K2 is controlled by a control signal outputted from a port GATE of the control unit 20. A capacitor C3 is further connected between the input voltage Vᵢₙ and the ground end SGND.

Please continue to refer to FIG. 1, in some embodiments of the present disclosure, the power control device 100 may further have a secondary current detection unit 80 for detecting a secondary current I1, which is connected between a secondary circuit 12 and the load 40, and connected to a control unit 50. The control unit 20 and the load 40 are in communication connection through the communication line CC. When the input voltage signal A is the low-voltage input, the control unit 20 may announce to the load 40 through the communication line CC that the power control device 100 has a first current pumping capability, and limits an overcurrent protection current threshold of the secondary circuit 12 to be a first current value, and when the input voltage signal A is the high-voltage input, the control unit 20 may announce to the load 40 through the communication line CC that the power control device 100 has a second current pumping capability, and limits an overcurrent protection current threshold of the secondary circuit 12 to be a second current value. Taking the power control device 100 being a power adapter having a rated power 100 W for example, when the input voltage signal A is the low-voltage input 100 Vac, the control unit 20 may announce to the load 40 through the communication line CC that the power control device 100 has a current pumping capability 5 A (i.e., the first current pumping capability), allows the continuous working rated power to be 100 W, and limits the overcurrent protection current threshold (i.e., OCP) of the secondary circuit 12 to be 6.5 A (i.e., the first current value). When the input voltage signal A is the high-voltage input 230Vac, the control unit 20 announces that the power control device 100 has a current pumping capability 6.5 A (i.e., the second current pumping capability), allows the continuous working rated power to be switched to 130 W, increases a power output capability 30 W, and limits the overcurrent protection current threshold (i.e., OCP) of the secondary circuit 12 to be 7.5 A (i.e., the second current value). The current value (such as, 5 A) corresponding to the first current pumping capability is less than the current value (such as, 6.5 A) corresponding to the second current pumping capability, and the first current value (such as, 6.5 A) is less than the second current value (such as, 7.5 A).

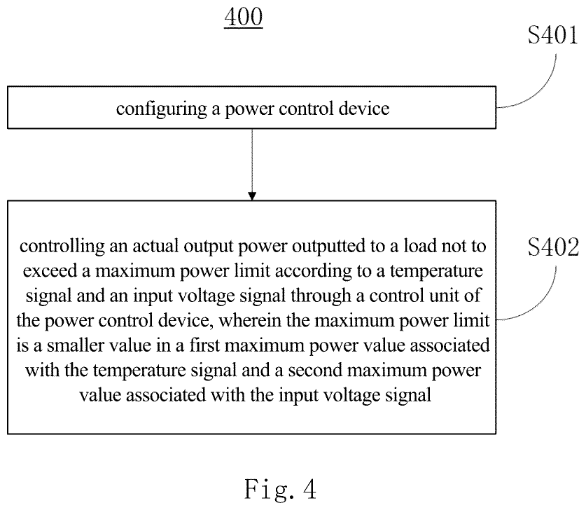

As shown in FIG. 4, it shows flows of a power control method 400 according to the present disclosure. The power control method 400 mainly includes:
S401: configuring a power control device (including but not limited to the power control device 100);
S402: controlling an actual output power outputted to a load not to exceed a maximum power limit according to a temperature signal and an input voltage signal through a control unit of the power control device, wherein the maximum power limit is a smaller value in a first maximum power value associated with the temperature signal and a second maximum power value associated with the input voltage signal.

As can be seen, the present disclosure enables the power control device (such as, the power adapter, etc.) to release the output power to the maximum extent according to different input voltages and combining with the actual detection temperature using the characteristic that the power transmission efficiency under the high- and low-voltage AC inputs differs. For example, when under the low-voltage input, the power adapter can run fora long-term maximum at a first output power P1 (i.e., the first voltage allowable power), and when under the high-voltage input, the power adapter can run for a long-term maximum at a second output power P2 (i.e., the second voltage allowable power) (P2>P1).

In addition, the present disclosure can also give the currently allowable maximum rated output power according to the actual mains input voltage, and actively guide loads (such as, PCs, cell phones, etc.) for pumping using the power adapter of the present disclosure through the control unit 20, such as, USB PD control chip (integrated MCU) assisting with a detection circuit of a primary input voltage and a temperature detection circuit.

Similarly, taking a power adapter with a rated output 20Vac/5 A for example, the rated power on the safety standard label corresponds to 100 W, which is applicable to the mains voltage input within the global range, but in practice, there is case that the clients only require to satisfy the standard CCC, i.e., selling only in Chinese mainland, meaning the case that the products only use 220 Vac input. When the input voltage is 220 Vac, the overall temperature rise is small, and actually, it can continuously work at 120 W or even higher power. The power adapter of the present disclosure may give the currently allowable maximum rated output power according to the actual mains input voltage by using the USB PD control chip (integrated MCU) assisting with the detection circuit of the primary input voltage and the temperature detection circuit, thereby guiding the loads (PCs, cell phones, etc.) for pumping.

In conclusion, the present disclosure can self-adaptively set limits of different rated output powers according to different mains inputs and actual working temperature, determine the current power transmission capability of the power source, actively guide current pumping at a system end, and release the output power to the maximum extent.

The exemplary embodiments of the present disclosure are illustrated and described in details. It shall be understood that the present disclosure is not limited to the disclosed embodiments. In contrast, the present disclosure intends to cover various modifications and equivalent arrangements included in spirit and scope of the appended claims.

What is claimed is:

1. A power control device, comprising:
a power conversion unit having a primary circuit and a secondary circuit connected through a transformer, wherein the power conversion unit is configured to receive an AC input voltage of an AC power source and convert the AC input voltage into an output voltage for a load; and
a control unit configured to control an actual output power not to exceed a maximum power limit according to a temperature signal and an input voltage signal, wherein the maximum power limit is the smaller one between a first maximum power value and a second maximum power value, and the first maximum power value is associated with the temperature signal and the second maximum power value is associated with the input voltage signal.

2. The power control device according to claim 1, wherein the control unit is further configured to:
when the input voltage signal corresponds to a first voltage, the first power threshold is used as the second maximum power value;
when the input voltage signal corresponds to a second voltage, the second power threshold is used as the second maximum power value, wherein the first voltage is smaller than the second voltage, and the second power threshold is greater than the first power threshold.

3. The power control device according to claim 2, wherein the power control device is a power adapter, and the first power threshold is equal to a rated power of the power adapter, and the second power threshold is greater than the rated power of the power adapter.

4. The power control device according to claim 1, wherein the input voltage signal is detected by a voltage detection unit, and the voltage detection unit has a detection node between the AC power source and the primary circuit.

5. The power control device according to claim 4, further comprising a rectifier circuit having an input end electrically coupled to an output end of the AC power source and an output end electrically coupled to the primary circuit, wherein the detection node is located at the output end of the AC power source or the output end of the rectifier circuit.

6. The power control device according to claim 5, further comprising a power factor correction circuit electrically coupled between the output end of the rectifier circuit and the primary circuit, wherein the input voltage signal is detected from the output end of the rectifier circuit before the power factor correction circuit starts up.

7. The power control device according to claim 1, wherein the control unit is further configured to:
when the temperature signal is less than a first temperature threshold, the third power threshold is used as the first maximum power value;
when the temperature signal is greater than a second temperature threshold, the control unit performs over-temperature protection for the power control device;
when the temperature signal is between the first temperature threshold and the second temperature threshold, a fourth power threshold is used as the first maximum power value;
wherein the first temperature threshold is less than the second temperature threshold, and the third power threshold is greater than the fourth power threshold.

8. The power control device according to claim 7, wherein the power control device is a power adapter, the first temperature threshold is 80° C., and the third power threshold is 120% of a rated power of the power adapter, and the second temperature threshold is 100° C., and the fourth power threshold is the rated power of the power adapter.

9. The power control device according to claim 1, wherein the temperature signal is detected by sampling a temperature of the power control device itself.

10. The power control device according to claim 4, wherein the voltage detection unit is further configured to process the input voltage signal, such that the processed input voltage signal is identified as a first voltage or a second voltage by the control unit, wherein the first voltage is smaller than the second voltage.

11. The power control device according to claim 10, wherein the voltage detection unit comprises:
a plurality of voltage-dividing resistors at least comprising a first voltage-dividing resistor and a second voltage-dividing resistor sequentially connected in series between the detection node and a ground end;
a filter capacitor connected in parallel to the second voltage-dividing resistor;
a voltage comparator having a non-inverting input end connected to a reference voltage, an inverting input end connected to a junction node between the first voltage-dividing resistor and the second voltage-dividing resistor, and a power supply end connected to a DC power source, and a comparison output end; and
a switch having a switch input end connected to the comparison output end of the voltage comparator, and a switch output end;
wherein the power control device further comprises a signal isolation unit having a first input end and a first output end, wherein the first input end of the signal isolation unit is connected to the switch output end of the switch, and the first output end of the signal isolation unit is connected to the control unit.

12. The power control device according to claim 11, wherein the signal isolation unit is a optocoupler or a transformer.

13. The power control device according to claim 10, wherein the voltage detection unit comprises:
a plurality of voltage-dividing resistors at least comprising a first voltage-dividing resistor and a second voltage-dividing resistor sequentially connected in series between the detection node and a ground end, and a filter capacitor connected in parallel to the second voltage-dividing resistor;
a three-terminal voltage stabilizer having a cathode, an anode and a reference electrode, and a switching element having a drive end, a switch input end and a switch output end; and
a cathode resistor, a current-limiting resistor, a driving resistor and a voltage stabilizing diode, wherein the cathode resistor is electrically connected between a DC power source and the cathode of the three-terminal voltage stabilizer, the driving resistor and the voltage stabilizing diode are connected in series between the cathode of the three-terminal voltage stabilizer and the drive end of the switching element, and the current-limiting resistor is electrically connected between the DC power source and the switch input end of the switching element;
the power control device further comprising a signal isolation unit having a first input end and a first output end, wherein the first input end of the signal isolation unit is connected to the switch output end of the switching element, and the first output end of the signal isolation unit is connected to the control unit.

14. The power control device according to claim 13, wherein the signal isolation unit is a optocoupler or a transformer.

15. The power control device according to claim 1, further comprising:
a secondary current detection unit between the secondary circuit and the load, wherein the secondary current detection unit is electrically connected to the control unit;
the control unit further in communication connection with the load through a communication line;
wherein when the input voltage signal is corresponds to a first voltage, the control unit indicates that the power control device has a first current pumping capability, and limits an overcurrent protection current threshold of the secondary circuit to be a first current value;
wherein when the input voltage signal is corresponds to a second voltage, the control unit indicates that the power control device has a second current pumping capability, and limits the overcurrent protection current threshold of the secondary circuit to be a second current value;
wherein the first voltage is smaller than the second voltage, and the second power threshold is greater than the first power threshold, and a current value corresponding to the first current pumping capability is less than a current value corresponding to the second current pumping capability, and the first current value is less than the second current value.

16. The power control device according to claim 2, wherein the first voltage ranges from 100 Vac to 127Vac, and the second voltage ranges from 200 Vac to 240Vac.

17. The power control device according to claim 4, further comprising:
a signal isolation unit between the voltage detection unit and the control unit and electrically isolating the input voltage signal, wherein the control unit is electrically connected to the secondary circuit.

18. A power control method, comprising:
configuring the power control circuit according to claim 1;
the control unit controlling an actual output power not to exceed a maximum power limit according to a temperature signal and an input voltage signal, wherein the maximum power limit is the smaller one between a first maximum power value and a second maximum power value, and the first maximum power value is associated with the temperature signal and the second maximum power value is associated with the input voltage signal.
